(19) United States
(12) Patent Application Publication
(10) Pub. No.: US 2016/0328880 A1
(43) Pub. Date: Nov. 10, 2016

(54) FAUCET WITH DATA INPUT DEVICES AND COMMUNICATION MEANS

(71) Applicants: Adithi Sajapuram, Cupertino, CA (US); Uditha V. Velidandla, San Jose, CA (US)

(72) Inventors: Adithi Sajapuram, Cupertino, CA (US); Uditha V. Velidandla, San Jose, CA (US)

(21) Appl. No.: 14/704,354

(22) Filed: May 5, 2015

(51) Int. Cl. G06T 19/00; H04N 5/225; H04N 5/232; H04N 7/18; H04N 5/272

(52) U.S. Cl. CPC G06T 19/006; H04N 7/181; H04N 5/272; H04N 5/23241; H04N 5/2252

(57) ABSTRACT

A faucet includes a water valve, a handle that controls the valve, a water spout, a camera unit directed toward an operator of the faucet, and a data output means that is connected to the camera unit. In one example, a wireless communication link between a camera unit testing faucet and a mobile device is established, a wireless communication link between the mobile device and a processor unit coupled to a display is established, an image is captured via the camera unit, the captured image from the camera unit is communicated to the mobile device, a user of the mobile device is prompted to provide augmentation information, an augmented image is generated by the mobile device based on the captured image and the augmentation information provided by the user, the augmented image is communicated to the processor unit, the augmented image is displayed on the display device.

### TECHNICAL FIELD

The described embodiments relate generally to a faucet with a mounted camera and to a system using said faucet to generate an augmented image.

### SUMMARY

In a first novel aspect, a faucet includes a water valve, a handle that controls the valve, a water spout, a camera unit directed toward an operator of the faucet, and a data output means that is connected to the camera unit.

In a second novel aspect, a wireless communication link between a camera unit testing faucet and a mobile device is established, a wireless communication link between the mobile device and a processor unit coupled to a display is established, an image is captured via the camera unit, the captured image from the camera unit is communicated to the mobile device, a user of the mobile device is prompted to provide augmentation information, an augmented image is generated by the mobile device based on the captured image and the augmentation information provided by the user, the augmented image is communicated to the processor unit, the augmented image is displayed on the display device.

In a third novel aspect, a wake up signal is generated and communicated to a processor unit, an image is captured via a camera unit attached to a faucet that is in communication with the processor unit, the captured image is displayed on a display device, augmentation options are displayed on the display device, augmentation information is received from a user, an augmented image is generated by the processor unit based on the captured image and the augmentation information, and the augmented image is displayed on the display device.

In a fourth novel aspect, a mobile device controlled augmented image generation system with a faucet camera that includes a mounted projector unit. The augmented image generation system includes a faucet with the integrated camera and a mobile device. The augmented image generation system that allows a user to display an augmented version of their image on any surface behind the faucet camera. In one embodiment, the image is projected onto the wall behind faucet directly in front of the user.

Further details and embodiments and techniques are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 is a diagram of a faucet including a camera unit and a microphone with a wired output routed through the faucet hardware.

FIG. 2 is a diagram of a faucet including a camera unit and a microphone with a wired output routed outside of the faucet hardware.

FIG. 3 is a diagram of a faucet including a camera unit and microphone located at the extended end of the handle with a wired output routed through the faucet hardware.

FIG. 4 is a diagram of a faucet including a camera unit and a microphone with a wireless device.

FIG. 5 a diagram of a faucet including a camera unit and microphone located at the extended end of the handle with a wireless device.

FIG. 6 is a diagram of a mobile device controlled augmented image generation system with a faucet camera.

FIG. 7 is a diagram of a touch screen controlled augmented image generation system with a faucet camera.

FIG. 8 is a diagram of a voice controlled augmented image generation system with a faucet camera.

FIG. 9 is a flowchart describing the operation of a mobile device controlled augmented image generation system with a faucet camera.

FIG. 10 is a flowchart describing the operation of a touch screen controlled augmented image generation system with a faucet camera.

FIG. 11 is a flowchart describing the operation of a voice controlled augmented image generation system with a faucet camera.

FIG. 12 is a diagram of a mobile device controlled augmented image generation system with a faucet camera that includes a mounted projector unit.

### DETAILED DESCRIPTION

Reference will now be made in detail to background examples and some embodiments of the invention, examples of which are illustrated in the accompanying drawings. In the description and claims below, relational terms (such as “upper”, “uppermost”, “topmost”, “lower”, “bottom”, “bottommost”, “left” and “right”) may be used to describe relative orientations between different parts of a structure being described, and it is to be understood that the overall structure being described can actually be oriented in any way in three-dimensional space.

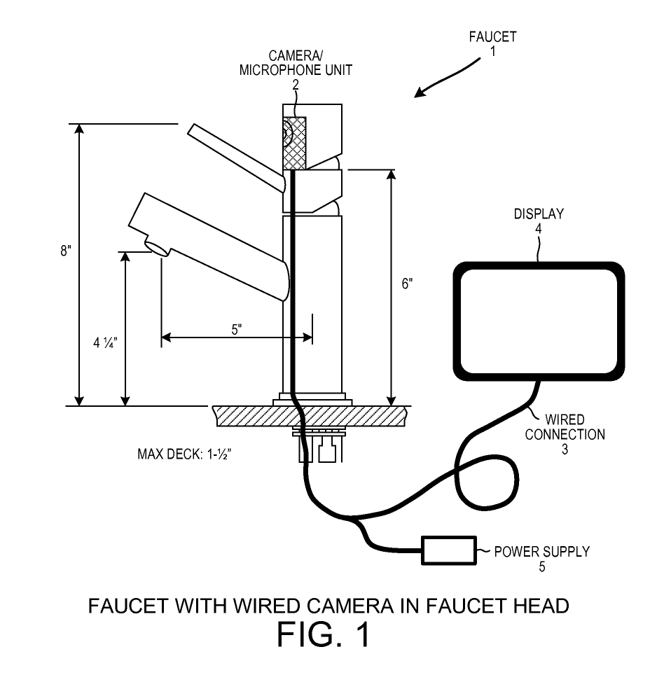

FIG. 1 is a diagram of a faucet including a camera unit and a microphone with a wired output routed through the faucet hardware. In FIG. 1 the camera unit 2 includes a microphone. In other embodiments, the microphone may be separate from the camera unit 2. The camera unit 2 is located in the head portion of the faucet. The head portion of the faucet is mounted to the top of the valve control portion of the faucet. The valve control portion of the faucet includes an extended lever that is used by a user of the faucet to control the flow of water. The valve control portion of the faucet is mounted to the top of the main body of the faucet. A waterspout protrudes from the main body of the faucet. When the valve is in an open position, water flows out of the waterspout.

A communication wire is attached to the camera unit 2 and is routed through the head portion of the faucet, the valve control portion of the faucet, and the main body portion of the faucet. The communication wire exits the faucet at the bottom of the main body portion and extends beneath the counter top to which the faucet is attached. The communication wire further extends to a display device 4. In one example display device 4 is a LCD screen connected to a standard such that the user of the faucet can view the images displayed on the display. In another example the display device 4 is mounted to a wall located directly in front of the user of the faucet. In yet another example, the displays mounted on a wall located directly from the user faucet and is covered by a controllably reflective surface. The controllably reflective surface can be set to be either transparent or reflective. The controllably reflective surface allows the wall behind the faucet to provide a mirror function when desired, and provide a transparent surface through which images shown on the display can be viewed by the user of the faucet. The camera unit 2 includes one or more lenses and one or more light sensing elements. In one example the camera unit 2 includes a microprocessor that performs auto focusing and exposure control. In another example, the camera unit 2 includes a microprocessor that performs automatic audio gain adjustment for the microphone. To ensure that the image of the user of the faucet is properly captured, a wide-angle lens may be included in the camera unit 2. In one example, the display device 4 also includes a processor unit. The processor unit can determine the portion of the captured image that includes the user of the faucet and will crop the rest of the captured image. Therefore only displaying the portion of the captured image that includes the user of the faucet. This combination of a wide-angle lens in a camera unit 2 and the image cropping software executed by the processor unit included in the display allows for easy operation by the user

Preventing water damage and corrosion of the camera unit 2 and a wired connection 3 is of the utmost importance. Prevention of water damage and corrosion is achieved by a variety of manufacturing precautions. Water damage and corrosion of the camera unit 2 is mitigated by providing a watertight seal around the perimeter of the head portion of the faucet that contains the camera unit 2. A watertight seal around the perimeter of the head portion of the faucet prevents water from leaking in during use and prevents moisture build up within the faucet from traveling up into the head portion of the faucet. The hole where the wired connection 3 exits the head portion of the faucet is of the utmost importance in the sealing process. In one example a rubber grommet can be used to ensure that no water or moisture enters the head portion of the faucet. In another example a sealing epoxy or silicone can be used to seal the space around the wire as it exits the head portion of the faucet.

Water damage and corrosion of the camera unit 2 is also mitigated by providing a clear waterproof surface through which the camera lens focuses. In one example the clear waterproof surfaces a plastic material where the edges of the plastic material are connected in a waterproof fashion to the head portion of the faucet. In one example the plastic material mates into a rubber grommet that fits into the head portion of the faucet. In another example the plastic material is attached to the head portion of the faucet with an epoxy or silicone.

Power supply 5 is optionally provided to power to the camera unit and the display. In one embodiment the power supply is an AC to DC power converter that plugs into a local wall outlet. In another embodiment, the power supply is a battery pack that supplies DC voltage to both the camera unit in the display. The battery pack may utilize one or more standard off-the-shelf batteries or may use a custom high-capacity battery.

Various dimensions of the faucet are provided in FIG. 1. These dimensions are only exemplary and are in no way limiting to other possible dimensions of said faucet.

It is also possible to attach the camera unit to the faucet without integrating the camera unit into the faucet. For example, the camera unit can be attached to the faucet with: a Velcro strap, a clamp, an epoxy, a double sided adhesive tape, a screw, a nut, a suction cup, and a band.

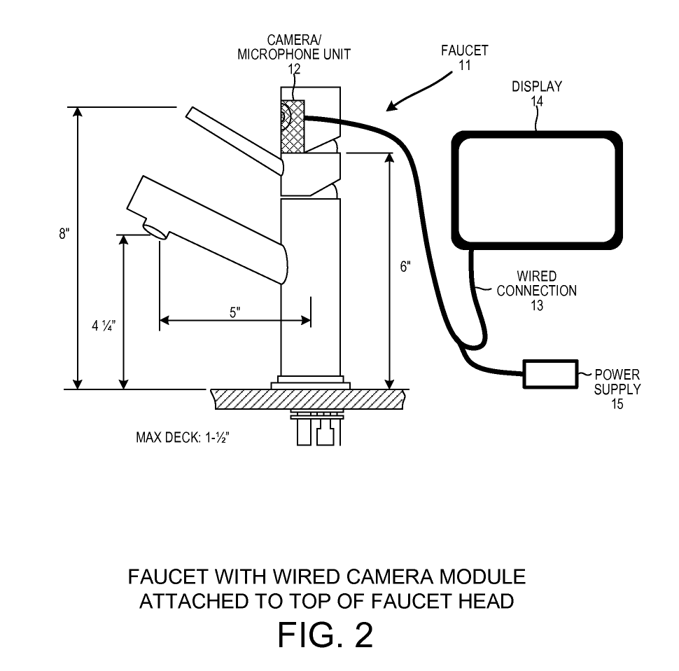

FIG. 2 is a diagram of a faucet including a camera unit and a microphone with a wired output routed outside of the faucet hardware. In FIG. 2 the camera unit 12 includes a microphone. In other embodiments, the microphone may be separate from the camera unit 12. The camera unit 12 is located in the head portion of the faucet. The head portion of the faucet is mounted to the top of the valve control portion of the faucet. The valve control portion of the faucet includes an extended lever that is used by a user of the faucet to control the flow of water. The valve control portion of the faucet is mounted to the top of the main body of the faucet. A waterspout protrudes from the main body of the faucet. When the valve is in an open position, water flows out of the waterspout.

A communication wire is attached to the camera unit 12 and is routed through the head portion of the faucet and exits the head portion of the faucet on the rear surface of the head portion of the faucet. The communication wire 13 extends Abe of the counter top to which the faucet is attached. The communication wire further extends to a display device 14. In one example display device 14 is a LCD screen connected to a standard such that the user of the faucet can view the images displayed on the display. In another example the display device 14 is mounted to a wall located directly in front of the user of the faucet. In yet another example, the displays mounted on a wall located directly from the user faucet and is covered by a controllably reflective surface. The controllably reflective surface can be set to be either transparent or reflective. The controllably reflective surface allows the wall behind the faucet to provide a mirror function when desired, and provide a transparent surface through which images shown on the display can be viewed by the user of the faucet. The camera unit 12 includes one or more lenses and one or more light sensing elements. In one example the camera unit 12 includes a microprocessor that performs auto focusing and exposure control. In another example, the camera unit 12 includes a microprocessor that performs automatic audio gain adjustment for the microphone. To ensure that the image of the user of the faucet is properly captured, a wide-angle lens may be included in the camera unit 12. In one example, the display device 14 also includes a processor unit. The processor unit can determine the portion of the captured image that includes the user of the faucet and will crop the rest of the captured image. Therefore only displaying the portion of the captured image that includes the user of the faucet. This combination of a wide-angle lens in a camera unit 12 and the image cropping software executed by the processor unit included in the display allows for easy operation by the user

Preventing water damage and corrosion of the camera unit 12 and a wired connection 13 is of the utmost importance. Prevention of water damage and corrosion is achieved by a variety of manufacturing precautions. Water damage and corrosion of the camera unit 12 is mitigated by providing a watertight seal around the perimeter of the head portion of the faucet that contains the camera unit 12. A watertight seal around the perimeter of the head portion of the faucet prevents water from leaking in during use and prevents moisture build up within the faucet from traveling up into the head portion of the faucet. The hole where the wired connection 13 exits the head portion of the faucet is of the utmost importance in the sealing process. In one example a rubber grommet can be used to ensure that no water or moisture enters the head portion of the faucet. In another example a sealing epoxy or silicone can be used to seal the space around the wire as it exits the head portion of the faucet.

Water damage and corrosion of the camera unit 12 is also mitigated by providing a clear waterproof surface through which the camera lens focuses. In one example the clear waterproof surfaces a plastic material where the edges of the plastic material are connected in a waterproof fashion to the head portion of the faucet. In one example the plastic material mates into a rubber grommet that fits into the head portion of the faucet. In another example the plastic material is attached to the head portion of the faucet with an epoxy or silicone. Water damage and corrosion of the wired connection 13 can be mitigated by using a waterproof rubber jacket around the wired connection.

Power supply 15 is optionally provided to power to the camera unit and the display. In one embodiment the power supply is an AC to DC power converter that plugs into a local wall outlet. In another embodiment, the power supply is a battery pack that supplies DC voltage to both the camera unit in the display. The battery pack may utilize one or more standard off-the-shelf batteries or may use a custom high-capacity battery.

Various dimensions of the faucet are provided in FIG. 2. These dimensions are only exemplary and are in no way limiting to other possible dimensions of said faucet.

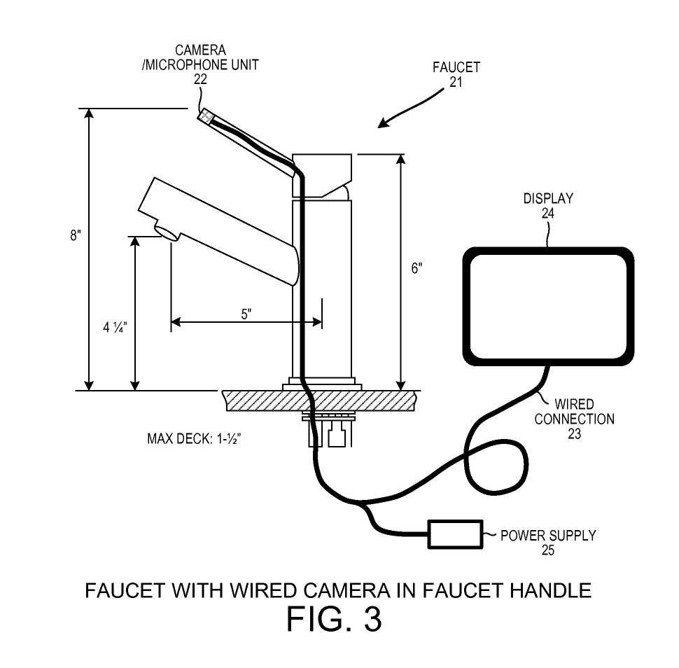

FIG. 3 is a diagram of a faucet including a camera unit and microphone located at the extended end of the handle with a wired output routed through the faucet hardware. In FIG. 3 the camera unit 22 includes a microphone. In other embodiments, the microphone may be separate from the camera unit 22. The valve control portion of the faucet includes an extended lever that is used by a user of the faucet to control the flow of water. The camera unit 22 is located in the extended end of the lever. The valve control portion of the faucet is mounted to the top of the main body of the faucet. A waterspout protrudes from the main body of the faucet. When the valve is in an open position, water flows out of the waterspout.

A communication wire 13 is attached to the camera unit 22 and is routed through the lever and valve portion of the faucet and exits the valve portion of the faucet and through the main body portion of the faucet. The communication wire 23 exits the faucet through the bottom of the main portion of the faucet to the space beneath the counter to which the faucet is attached. The communication wire further extends to a display device 24. In one example display device 24 is a LCD screen connected to a standard such that the user of the faucet can view the images displayed on the display. In another example the display device 24 is mounted to a wall located directly in front of the user of the faucet. In yet another example, the displays mounted on a wall located directly from the user faucet and is covered by a controllably reflective surface. The controllably reflective surface can be set to be either transparent or reflective. The controllably reflective surface allows the wall behind the faucet to provide a mirror function when desired, and provide a transparent surface through which images shown on the display can be viewed by the user of the faucet. The camera unit 22 includes one or more lenses and one or more light sensing elements. In one example the camera unit 22 includes a microprocessor that performs auto focusing and exposure control. In another example, the camera unit 22 includes a microprocessor that performs automatic audio gain adjustment for the microphone. To ensure that the image of the user of the faucet is properly captured, a wide-angle lens may be included in the camera unit 22. In one example, the display device 24 also includes a processor unit. The processor unit can determine the portion of the captured image that includes the user of the faucet and will crop the rest of the captured image. Therefore only displaying the portion of the captured image that includes the user of the faucet. This combination of a wide-angle lens in a camera unit 22 and the image cropping software executed by the processor unit included in the display allows for easy operation by the user

Preventing water damage and corrosion of the camera unit 22 and a wired connection 23 is of the utmost importance. Prevention of water damage and corrosion is achieved by a variety of manufacturing precautions. Water damage and corrosion of the camera unit 22 is mitigated by providing a watertight seal around the perimeter of the valve portion of the faucet that contains the camera unit 22. A watertight seal around the perimeter of the valve portion of the faucet prevents water from leaking in during use and prevents moisture build up within the faucet from traveling up into the valve portion of the faucet. The hole where the wired connection 23 exits the valve portion of the faucet is of the utmost importance in the sealing process. In one example a rubber grommet can be used to ensure that no water or moisture enters the valve portion of the faucet. In another example a sealing epoxy or silicone can be used to seal the space around the wire as it exits the valve portion of the faucet.

Water damage and corrosion of the camera unit 22 is also mitigated by providing a clear waterproof surface through which the camera lens focuses. In one example the clear waterproof surfaces a plastic material where the edges of the plastic material are connected in a waterproof fashion to the valve portion of the faucet. In one example the plastic material mates into a rubber grommet that fits into the valve portion of the faucet. In another example the plastic material is attached to the valve portion of the faucet with an epoxy or silicone. Water damage and corrosion of the wired connection 23 can be mitigated by using a waterproof rubber jacket around the wired connection.

Power supply 25 is optionally provided to power to the camera unit and the display. In one embodiment the power supply is an AC to DC power converter that plugs into a local wall outlet. In another embodiment, the power supply is a battery pack that supplies DC voltage to both the camera unit in the display. The battery pack may utilize one or more standard off-the-shelf batteries or may use a custom high-capacity battery.

Various dimensions of the faucet are provided in FIG. 3. These dimensions are only exemplary and are in no way limiting to other possible dimensions of said faucet.

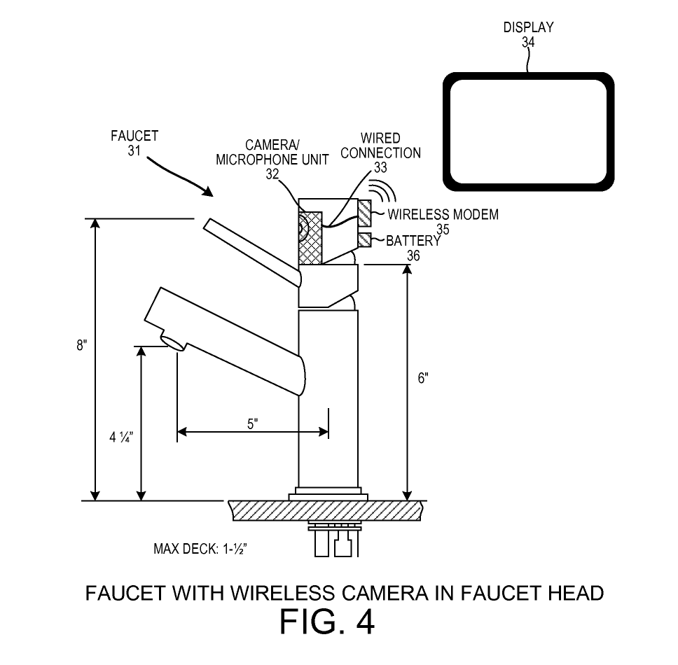

FIG. 4 is a diagram of a faucet including a camera unit and a microphone with a wireless device. In FIG. 4 the camera unit 32 includes a microphone. In other embodiments, the microphone may be separate from the camera unit 32. The camera unit 32 is located in the head portion of the faucet. The head portion of the faucet is mounted to the top of the valve control portion of the faucet. The valve control portion of the faucet includes an extended lever that is used by a user of the faucet to control the flow of water. The valve control portion of the faucet is mounted to the top of the main body of the faucet. A waterspout protrudes from the main body of the faucet. When the valve is in an open position, water flows out of the waterspout.

A communication wire 33 is attached to the camera unit 32 and is routed through the head portion of the faucet. The communication wire exits the faucet at the back surface of the head portion of the faucet. The communication wire further extends to a wireless device 35. In one example the wireless device is mounted to the backside of the head portion of the faucet. The wireless device can be mounted using an epoxy, screw, double-sided tape, a clip, or a securing band. The wireless device is configured to communicate via one of many standard wireless communication protocols. Examples of standard wireless communication protocols include Bluetooth, ZigBee, GSM, Wi-Fi, LTE, and 3G. Other wireless communication standard uses a well. The wireless device is configured to communicate wirelessly with display device 34. Display device 34 includes a wireless device that is capable of communication with wireless device 35. In one example display device 34 is a LCD screen connected to a stand such that the user of the faucet can view the images displayed on the display. In another example the display device 34 is mounted to a wall located directly in front of the user of the faucet. In yet another example, the displays mounted on a wall located directly from the user faucet and is covered by a controllably reflective surface. The controllably reflective surface can be set to be either transparent or reflective. The controllably reflective surface allows the wall behind the faucet to provide a mirror function when desired, and provide a transparent surface through which images shown on the display can be viewed by the user of the faucet. The camera unit 32 includes one or more lenses and one or more light sensing elements. In one example the camera unit 32 includes a microprocessor that performs auto focusing and exposure control. In another example, the camera unit 32 includes a microprocessor that performs automatic audio gain adjustment for the microphone. To ensure that the image of the user of the faucet is properly captured, a wide-angle lens may be included in the camera unit 32. In one example, the display device 34 also includes a processor unit. The processor unit can determine the portion of the captured image that includes the user of the faucet and will crop the rest of the captured image. Therefore only displaying the portion of the captured image that includes the user of the faucet. This combination of a wide-angle lens in a camera unit 32 and the image cropping software executed by the processor unit included in the display allows for easy operation by the user

Preventing water damage and corrosion of the camera unit 32 and a wired connection 33 is of the utmost importance. Prevention of water damage and corrosion is achieved by a variety of manufacturing precautions. Water damage and corrosion of the camera unit 32 is mitigated by providing a watertight seal around the perimeter of the head portion of the faucet that contains the camera unit 32. A watertight seal around the perimeter of the head portion of the faucet prevents water from leaking in during use and prevents moisture build up within the faucet from traveling up into the head portion of the faucet. The hole where the wired connection 33 exits the head portion of the faucet is of the utmost importance in the sealing process. In one example a rubber grommet can be used to ensure that no water or moisture enters the head portion of the faucet. In another example a sealing epoxy or silicone can be used to seal the space around the wire as it exits the head portion of the faucet.

Water damage and corrosion of the camera unit 32 is also mitigated by providing a clear waterproof surface through which the camera lens focuses. In one example the clear waterproof surfaces a plastic material where the edges of the plastic material are connected in a waterproof fashion to the head portion of the faucet. In one example the plastic material mates into a rubber grommet that fits into the head portion of the faucet. In another example the plastic material is attached to the head portion of the faucet with an epoxy or silicone.

Battery 36 is optionally provided to power to the camera unit and the wireless device. The power supply is a battery pack that supplies DC voltage to both the camera unit in the wireless device. The battery pack may utilize one or more standard off-the-shelf batteries or may use a custom high-capacity battery. In one embodiment, the batteries method exterior housing of the head portion of the faucet. In another embodiment (not shown), the battery is located inside the head portion of the faucet.

Various dimensions of the faucet are provided in FIG. 4. These dimensions are only exemplary and are in no way limiting to other possible dimensions of said faucet.

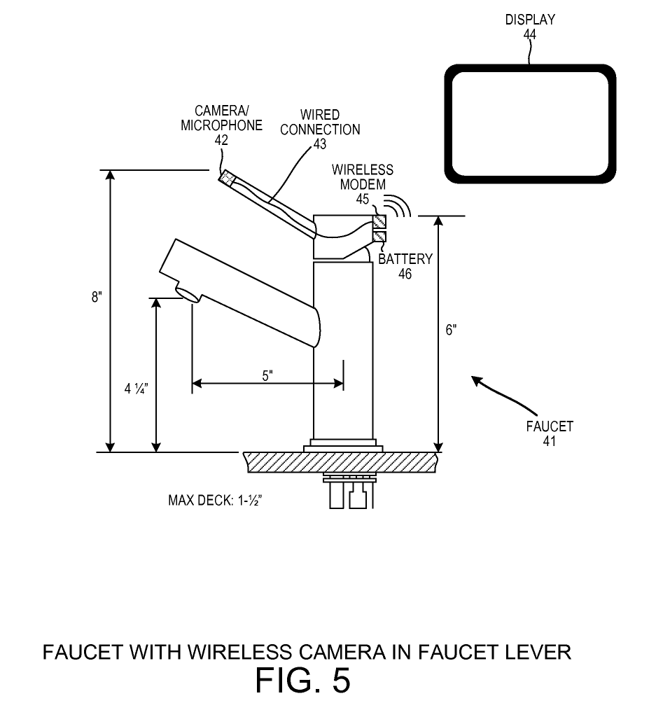

FIG. 5 a diagram of a faucet including a camera unit and microphone located at the extended end of the handle with a wireless device. In FIG. 5 the camera unit 42 includes a microphone. In other embodiments, the microphone may be separate from the camera unit 42. The valve control portion of the faucet includes an extended lever that is used by a user of the faucet to control the flow of water. The camera unit 42 is located in the extended end of the lever. The valve control portion of the faucet is mounted to the top of the main body of the faucet. A waterspout protrudes from the main body of the faucet. When the valve is in an open position, water flows out of the waterspout.

A communication wire 43 is attached to the camera unit 42 and is routed through the lever portion of the faucet is to a wireless device 45. The communication wire exits the faucet at the back surface of the lever portion of the faucet. The communication wire further extends to a wireless device 45. In one example the wireless device is mounted to the backside of the lever portion of the faucet. The wireless device can be mounted using an epoxy, screw, double-sided tape, a clip, or a securing band. The wireless device is configured to communicate via one of many standard wireless communication protocols. Examples of standard wireless communication protocols include Bluetooth, ZigBee, GSM, Wi-Fi, LTE, and 3G. Other wireless communication standard uses a well. The wireless device is configured to communicate wirelessly with display device 44. Display device is 44 includes a wireless device that is capable of communication with wireless device 45. In one example display device 44 is a LCD screen connected to a stand such that the user of the faucet can view the images displayed on the display. In another example the display device 44 is mounted to a wall located directly in front of the user of the faucet. In yet another example, the displays mounted on a wall located directly from the user faucet and is covered by a controllably reflective surface. The controllably reflective surface can be set to be either transparent or reflective. The controllably reflective surface allows the wall behind the faucet to provide a mirror function when desired, and provide a transparent surface through which images shown on the display can be viewed by the user of the faucet. The camera unit 42 includes one or more lenses and one or more light sensing elements. In one example the camera unit 42 includes a microprocessor that performs auto focusing and exposure control. In another example, the camera unit 42 includes a microprocessor that performs automatic audio gain adjustment for the microphone. To ensure that the image of the user of the faucet is properly captured, a wide-angle lens may be included in the camera unit 42. In one example, the display device 44 also includes a processor unit. The processor unit can determine the portion of the captured image that includes the user of the faucet and will crop the rest of the captured image. Therefore only displaying the portion of the captured image that includes the user of the faucet. This combination of a wide-angle lens in a camera unit 42 and the image cropping software executed by the processor unit included in the display allows for easy operation by the user

Preventing water damage and corrosion of the camera unit 42 and a wired connection 43 is of the utmost importance. Prevention of water damage and corrosion is achieved by a variety of manufacturing precautions. Water damage and corrosion of the camera unit 42 is mitigated by providing a watertight seal around the perimeter of the lever portion of the faucet that contains the camera unit 42. A watertight seal around the perimeter of the lever portion of the faucet prevents water from leaking in during use and prevents moisture build up within the faucet from traveling up into the lever portion of the faucet. The hole where the wired connection 33 exits the lever portion of the faucet is of the utmost importance in the sealing process. In one example a rubber grommet can be used to ensure that no water or moisture enters the lever portion of the faucet. In another example a sealing epoxy or silicone can be used to seal the space around the wire as it exits the lever portion of the faucet.

Water damage and corrosion of the camera unit 42 is also mitigated by providing a clear waterproof surface through which the camera lens focuses. In one example the clear waterproof surfaces a plastic material where the edges of the plastic material are connected in a waterproof fashion to the lever portion of the faucet. In one example the plastic material mates into a rubber grommet that fits into the lever portion of the faucet. In another example the plastic material is attached to the lever portion of the faucet with an epoxy or silicone.

Battery 46 is optionally provided to power to the camera unit and the wireless device. The power supply is a battery pack that supplies DC voltage to both the camera unit in the wireless device. The battery pack may utilize one or more standard off-the-shelf batteries or may use a custom high-capacity battery. In one embodiment, the batteries method exterior housing of the head portion of the faucet. In another embodiment (not shown), the battery is located inside the head portion of the faucet.

Various dimensions of the faucet are provided in FIG. 5. These dimensions are only exemplary and are in no way limiting to other possible dimensions of said faucet.

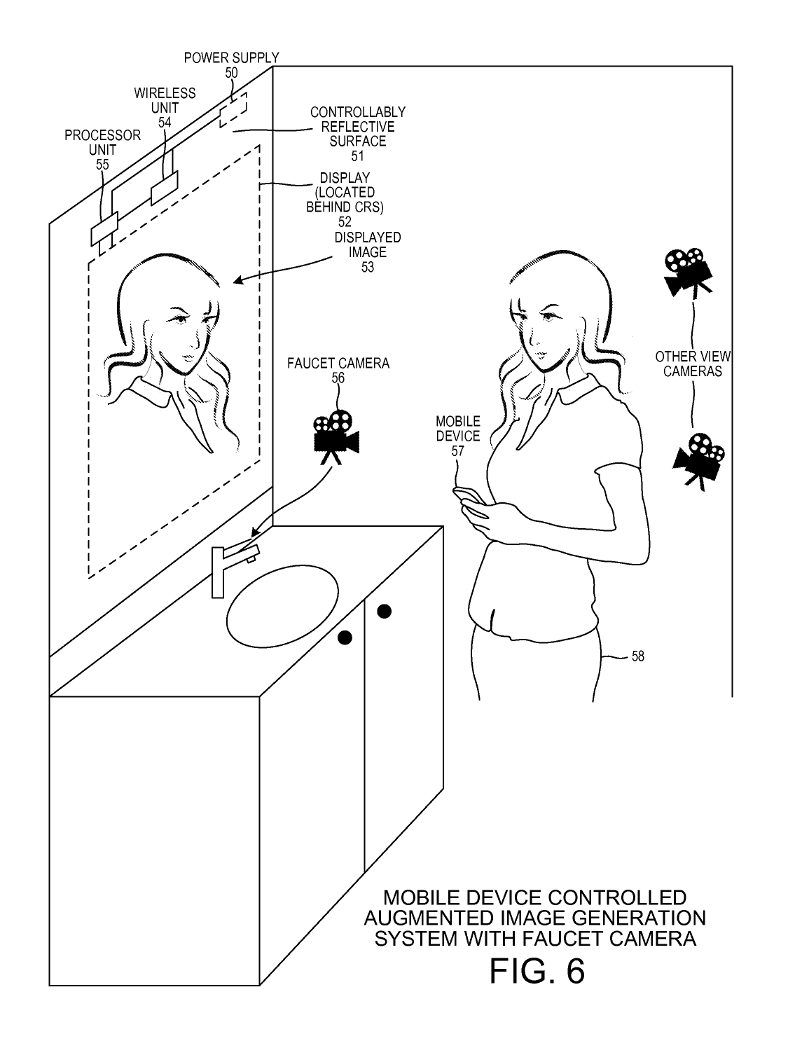

FIG. 6 is a diagram of a mobile device controlled augmented image generation system with a faucet camera. The augmented image generation system includes a faucet with the integrated camera 56, a display 52 coupled to a processing unit 55 and a wireless unit 54, a mobile device 57, and a controllably reflective surface 51 (optional). The augmented image generation system that allows a user 58 to display an augmented version of their image on the display. FIG. 6 illustrates an example where the display is mounted on the wall behind faucet directly in front of the user. The display is covered by a Controllable Reflective Surface (CRS) that can be in a transparent state or a reflective state, thereby allowing the user to either view their reflection or the augmented image displayed on the display. One example of a CRS is a reversible electrochemical mirror consisting of a thin layer of silver-containing electrolyte sandwiched between two transparent electrode panes. When a reduction voltage is applied, a reflective layer of metallic silver is deposited onto the electrode surface. Applying an oxidising potential dissolves the mirror coating by ionising the metallic silver.

In operation the user causes the mobile device to initiate a wireless communication link with both the faucet camera and the display. In response to initiating the wireless communication links, the mobile device prompts the user to stand within the focus range of the camera. The user then initiates image capturing via mobile device. The captured image is communicated wirelessly from the camera to the mobile device. The mobile device then prompt the user as to what type of image augmentation the user would like to be performed. The mobile device then performs the image augmentation and generates an augmented image that is based on the captured image and the augmentation information provided by the user. In one example the augmentation information is a preset makeup style, including different shades of lunch, eyeliner, and lipstick. In a second example the augmentation information includes hair color, hair length, and hairstyle. In a third example the augmentation information includes various clothing options, each in a selectable color and size. In a fourth example the augmentation information is limited to clothing owned by the user. In a fifth example the augmentation information is limited to makeup on by a user. The mobile device then communicates the augmented image to the display via the wireless unit and processing unit coupled to the display. The augmented image is then displayed on the display and can be viewed by the user standing in front of the display. The user can use the mobile device to update both the captured image and the augmentation information, and cause the mobile device to generate a new automated image based on the new captured image or the new augmentation information. In response to the updated, the mobile device will generate a new augmented image and communicate the new augmented image to the display which will in turn display the new augmented image.

The user can also share the augmented image with another person by sending the augmented image to another device. This operation is performed by prompting the user with a sharing option, whereby the mobile device in response to the user selecting the sharing option communicates the augmented image to a second device. In one example the second device may be owned and operated by a friend of the user. In another example the secondary device may be a server that serves the image to a group of people who are friends with the user. In a third example the secondary device may be owned by a makeup or clothing manufacturer that wishes to market makeup and/or clothing goods to the user.

In one example, once the mobile device establishes a communication link with the display, the processor unit sets the controllable reflective surface to transparent mode so that the user can see the images displayed on the display.

In another example once the mobile device turns off the communication link with the display, the processor unit sets the controllable reflective surface to reflective mode so that the user can see their reflection.

Power supply 50 is optionally provided to power to the processor unit, the wireless device, and the display. The power supply may also optionally power the camera unit located in faucet camera 56. In one embodiment the power supply is an AC to DC power converter that plugs into a local wall outlet. In another embodiment, the power supply is a battery pack that supplies DC voltage to both the camera unit in the display. The battery pack may utilize one or more standard off-the-shelf batteries or may use a custom high-capacity battery.

A faucet with an integrated camera and a wireless device, such as shown in FIGS. 4 and 5, can be used to implement the augmented image generation system shown in FIG. 6.

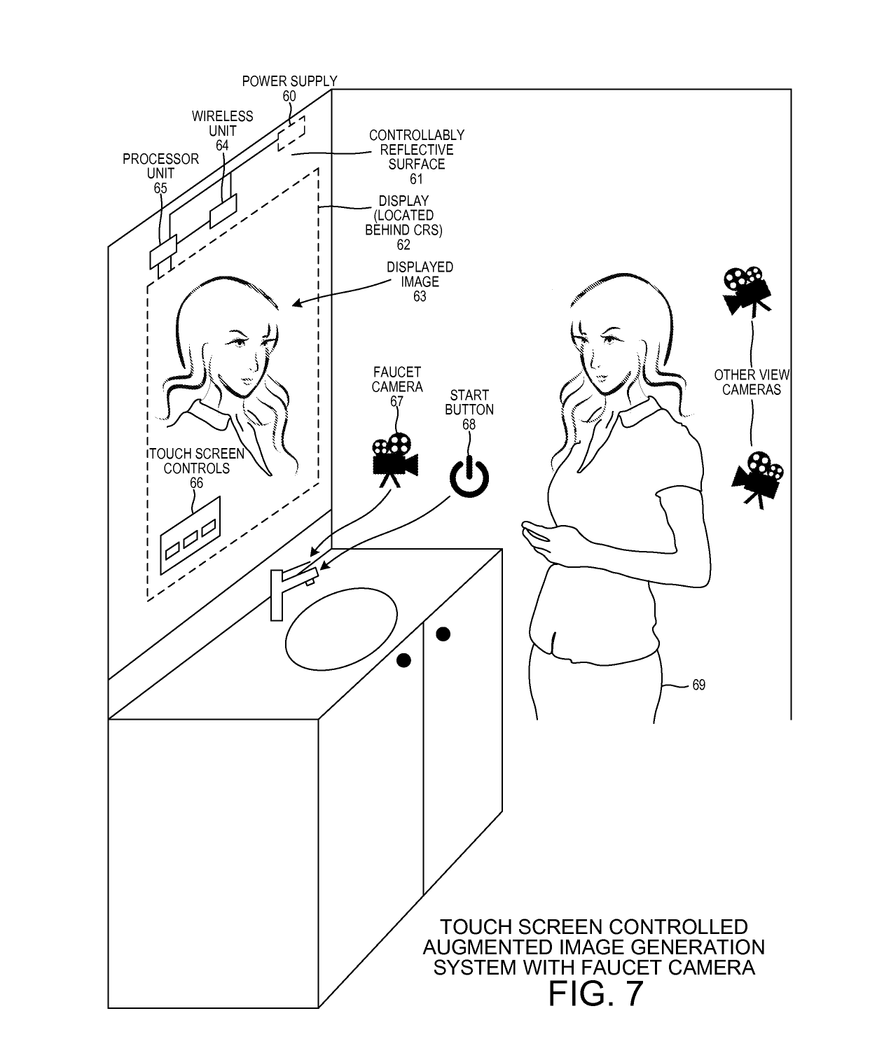

FIG. 7 is a diagram of a touch screen controlled augmented image generation system with a faucet camera. The augmented image generation system includes a faucet with the integrated camera 67, a display 62 coupled to a processing unit 65 and a wireless unit 64, a start button 68, and a controllably reflective surface 61 (optional). The augmented image generation system that allows a user 69 to display an augmented version of their image on the display. FIG. 7 illustrates an example where the display is mounted on the wall behind faucet directly in front of the user. The display is covered by a controllable reflective surface that can be in a transparent state or a reflective state, thereby allowing the user to either view their reflection or the augmented image displayed on the display.

In operation the user initiates the establishment of a wireless communication link between the faucet camera and the display by pressing the start button. When the start button is pressed a wake-up signal is communicated to the camera unit in the faucet which in turn causes a wireless device included in the faucet to wake up and establish a communication link with the wireless unit that is coupled to the processor unit in the display. In response to initiating the wireless communication link, the device prompts the user to stand within the focus range of the camera. The user then initiates image capturing via a touch screen that is included in the display. The captured image is communicated wirelessly from the camera to the processing unit via the wireless unit. The display then prompts the user as to what type of image augmentation the user would like to be performed. The processor unit then performs the image augmentation and generates an augmented image that is based on the captured image and the augmentation information provided by the user. In one example the augmentation information is a preset makeup style, including different shades of lunch, eyeliner, and lipstick. In a second example the augmentation information includes hair color, hair length, and hairstyle. In a third example the augmentation information includes various clothing options, each in a selectable color and size. In a fourth example the augmentation information is limited to clothing owned by the user. In a fifth example the augmentation information is limited to makeup on by a user. The processor unit then communicates the augmented image to the display. The augmented image is then displayed on the display and can be viewed by the user standing in front of the display. The user can use the touch screen to update both the captured image and the augmentation information, and cause the processor unit to generate a new automated image based on the new captured image or the new augmentation information. In response to the updated, the processor unit will generate a new augmented image and communicate the new augmented image to the display which will in turn display the new augmented image.

The user can also share the augmented image with another person by sending the augmented image to another device. This operation is performed by prompting the user with a sharing option, whereby the processor unit in response to the user selecting the sharing option communicates the augmented image to a second device via the wireless unit. In one example the second device may be owned and operated by a friend of the user. In another example the secondary device may be a server that serves the image to a group of people who are friends with the user. In a third example the secondary device may be owned by a makeup or clothing manufacturer that wishes to market makeup and/or clothing goods to the user.

In one example, once the wireless device on the faucet establishes a communication link with the display, the processor unit sets the controllable reflective surface to transparent mode so that the user can see the images displayed on the display.

In another example once the start button is pressed again the communication link with the display is turned off and the processor unit sets the controllable reflective surface to reflective mode so that the user can see their reflection.

Power supply 60 is optionally provided to power to the processor unit, the wireless device, and the display. The power supply may also optionally power the camera unit located in faucet camera 56. In one embodiment the power supply is an AC to DC power converter that plugs into a local wall outlet. In another embodiment, the power supply is a battery pack that supplies DC voltage to both the camera unit in the display. The battery pack may utilize one or more standard off-the-shelf batteries or may use a custom high-capacity battery.

A faucet with an integrated camera and a wireless device, such as shown in FIGS. 4 and 5, can be used to implement the augmented image generation system shown in FIG. 7.

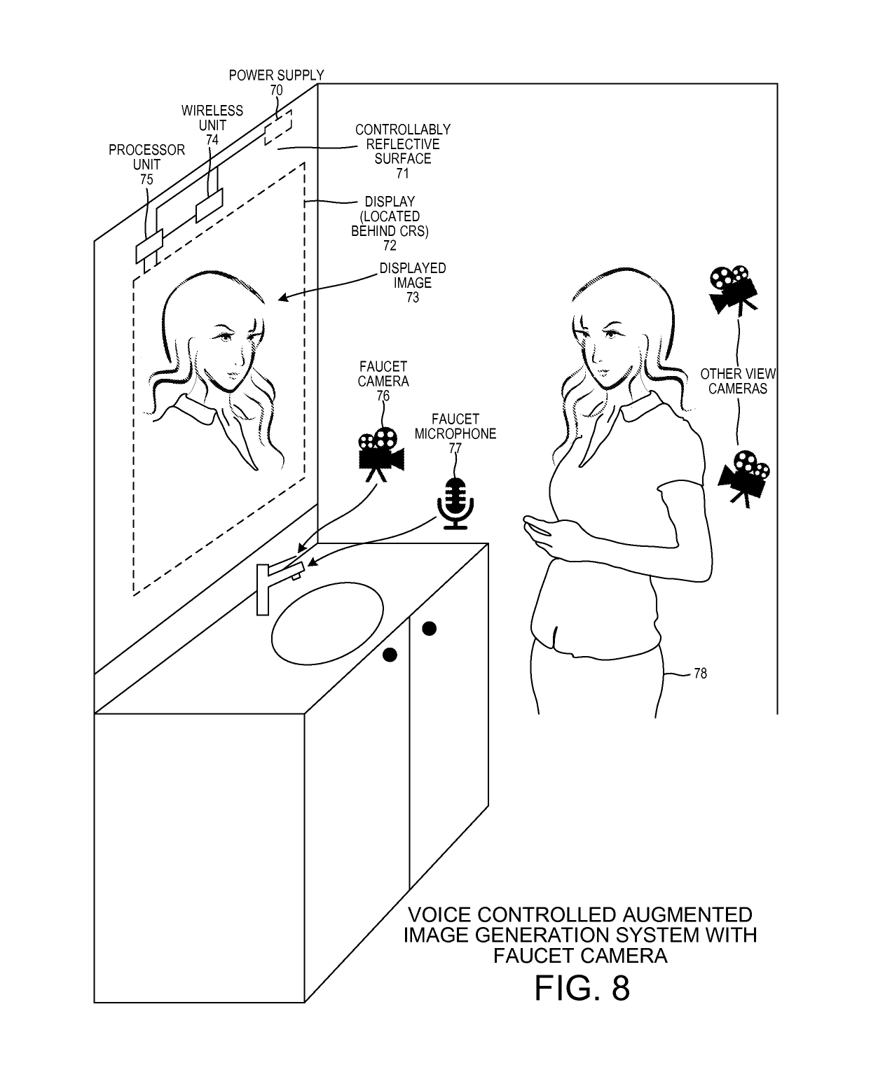

FIG. 8 is a diagram of a voice controlled augmented image generation system with a faucet camera. The augmented image generation system includes a faucet with the integrated camera 78, a display 72 coupled to a processing unit 75 and a wireless unit 74, an integrated microphone 77, and a controllably reflective surface 71 (optional). The augmented image generation system that allows a user 78 to display an augmented version of their image on the display. FIG. 8 illustrates an example where the display is mounted on the wall behind faucet directly in front of the user. The display is covered by a controllable reflective surface that can be in a transparent state or a reflective state, thereby allowing the user to either view their reflection or the augmented image displayed on the display.

In operation the user initiates the establishment of a wireless communication link between the faucet camera and the display by saying a turn on voice command. When the turn on voice command is received by the microphone in the faucet, a wireless device included in the faucet is caused to wake up and establish a communication link with the wireless unit that is coupled to the processor unit in the display. In response to initiating the wireless communication link, the device prompts the user to stand within the focus range of the camera. The user then initiates image capturing by saying a capture image command. The captured image is communicated wirelessly from the camera to the processing unit via the wireless unit. The display then prompts the user as to what type of image augmentation the user would like to be performed. The processor unit then performs the image augmentation and generates an augmented image that is based on the captured image and the augmentation information provided by the user. In one example the augmentation information is a preset makeup style, including different shades of lunch, eyeliner, and lipstick. In a second example the augmentation information includes hair color, hair length, and hairstyle. In a third example the augmentation information includes various clothing options, each in a selectable color and size. In a fourth example the augmentation information is limited to clothing owned by the user. In a fifth example the augmentation information is limited to makeup on by a user. The processor unit then communicates the augmented image to the display. The augmented image is then displayed on the display and can be viewed by the user standing in front of the display. The user can use voice commands to update both the captured image and the augmentation information, and cause the processor unit to generate a new automated image based on the new captured image or the new augmentation information. In response to the updated, the processor unit will generate a new augmented image and communicate the new augmented image to the display which will in turn display the new augmented image.

The user can also share the augmented image with another person by sending the augmented image to another device. This operation is performed by prompting the user with a sharing option, whereby the processor unit in response to the user selecting the sharing option communicates the augmented image to a second device via the wireless unit. In one example the second device may be owned and operated by a friend of the user. In another example the secondary device may be a server that serves the image to a group of people who are friends with the user. In a third example the secondary device may be owned by a makeup or clothing manufacturer that wishes to market makeup and/or clothing goods to the user.

In one example, once the wireless device on the faucet establishes a communication link with the display, the processor unit sets the controllable reflective surface to transparent mode so that the user can see the images displayed on the display.

In another example, when a turnoff command is said by a user, communication link with the display is turned off and the processor unit sets the controllable reflective surface to reflective mode so that the user can see their reflection.

A faucet with an integrated camera and microphone, and a wireless device, such as shown in FIGS. 4 and 5, can be used to implement the augmented image generation system shown in FIG. 8.

Power supply 70 is optionally provided to power to the processor unit, the wireless device, and the display. The power supply may also optionally power the camera unit located in faucet camera 56. In one embodiment the power supply is an AC to DC power converter that plugs into a local wall outlet. In another embodiment, the power supply is a battery pack that supplies DC voltage to both the camera unit in the display. The battery pack may utilize one or more standard off-the-shelf batteries or may use a custom high-capacity battery.

The example shown in FIGS. 6-8 all make a wireless communication link between the camera unit included in the faucet and the display; however, a similar system may be implemented using a wired communication link between the camera unit included in the faucet and the display, such as shown in the illustrations of the faucets provided in FIGS. 1-3.

FIGS. 6-8 also illustrate “other view cameras” located at other locations within the room and that are not attached to the faucet. These others cameras can comprise one or more additional cameras that are not attached to the faucet. Via the user interface described above, the user may display the view captured by any of the various cameras on the display. The other cameras may be connected to the wireless unit and processor unit by similar means as the camera unit within the faucet camera is connected to the wireless unit in the processor unit. In one embodiment, the other cameras are mounted to a different wall to which the display is mounted and are powered by a battery supply. In the preferred embodiment, the other cameras are mounted such as to provide a view of the back of the user and the side the user. The combination of the front view of the user provided by the faucet camera, the back view of the user provided by a first other camera, and decide you provided by a second other camera allows the user to observe their appearance in a 360° fashion. The other cameras may be attached to a surface using various attachment technologies, such as, a suction cup, Velcro, or a clip.

In one embodiment, the cameras illustrated in FIGS. 6-8 are directed at a fixed angle with the fixed zoom. In another embodiment, the camera directions can be manipulated by the user to view different locations on the user. In another embodiment, the zoom and focus of each camera can also be manipulated by the user to focus on different locations on the user. For example, the user may first manipulate the cameras to zoom out and focus on the user's entire person to view their wardrobe choice; then after deciding on one's wardrobe the user may manipulate the cameras to zoom in and focus on the user's face so that the user may view various makeup options with greater detail.

The cameras illustrated in FIGS. 6-8 may have various properties. For example the cameras may only capture black-and-white images. In another example the cameras to capture color images. This variation in picture resolution is another way in which the cameras properties. For example camera may be standard definition or high-definition for high-resolution viewing.

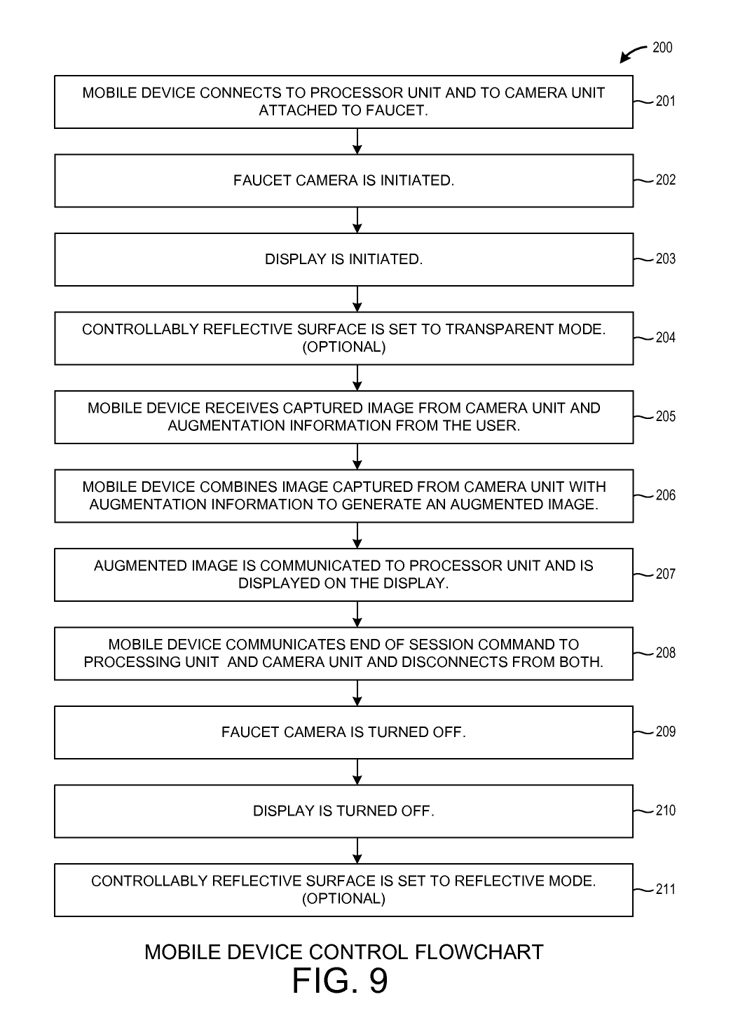

FIG. 9 is a flowchart 200 describing the operation of a mobile device controlled augmented image generation system with a faucet camera. In step 201, the mobile device connects to the processor unit into the camera unit attached to the faucet. In step 202, the faucet cameras initiated. In step 203, the display is initiated. In step 204, the controllably reflective surface is set to transparent mode (optional). In step 205, the mobile device receives a captured image from the camera unit and augmentation information from the user. In step 206 the mobile device combines the image captured from the camera unit with the augmentation information to generate an augmented image. In step 207 the augmented image is communicated to the processor unit and is displayed on the display. In step 208, the mobile device communicates an end of session command to the processing unit and the camera unit and disconnects from both the processor unit and the camera unit. In step 209 the faucet cameras turned off. In step 210, the display is turned off. In step 211, the controllably reflective surface is sent to reflective mode (optional).

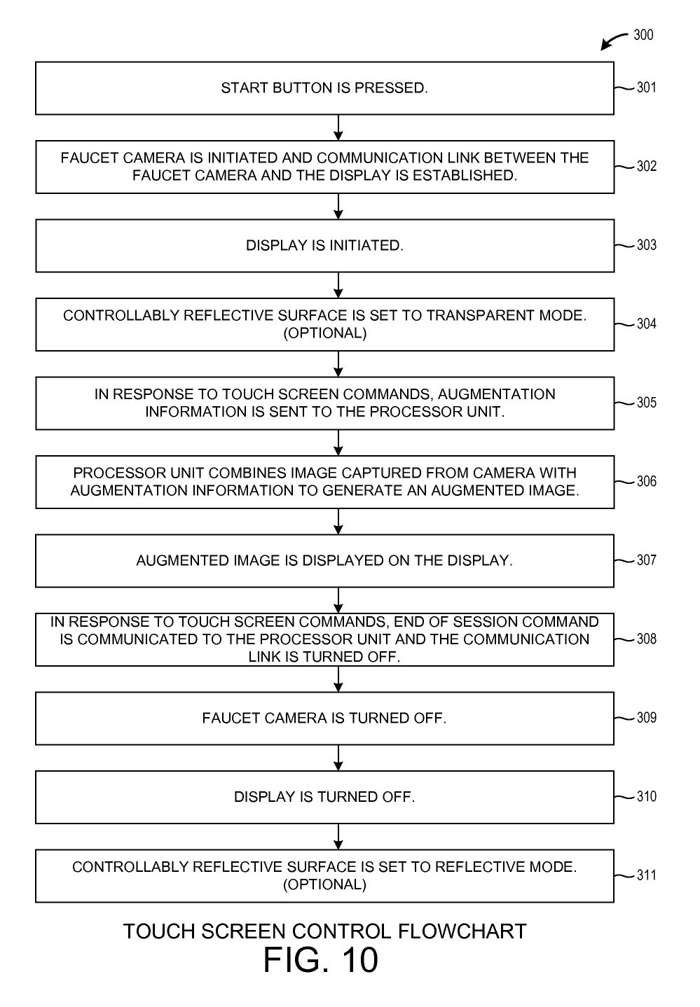

FIG. 10 is a flowchart 300 describing the operation of a touch screen controlled augmented image generation system with a faucet camera. In step 301, the start button is pressed. In step 302, the faucet cameras initiated. In step 303, the display is initiated. In step 304, the controllably reflective surface is sent to transparent mode (optional). In step 305, in response to touch screen commands the augmentation information is sent to the processing unit. In step 306, the processing unit combines the image capture from the camera with the augmentation information to generate an augmented image. In step 307, the augmented image is displayed in the display. In step 308, in response to the touch screen command, and an end of session command is sent to the processing unit and the communication link is turned off. In step 309, the faucet cameras turned off. In step 310, the display is turned off. In step 311, the controllably reflective surface is set to reflective mode (optional).

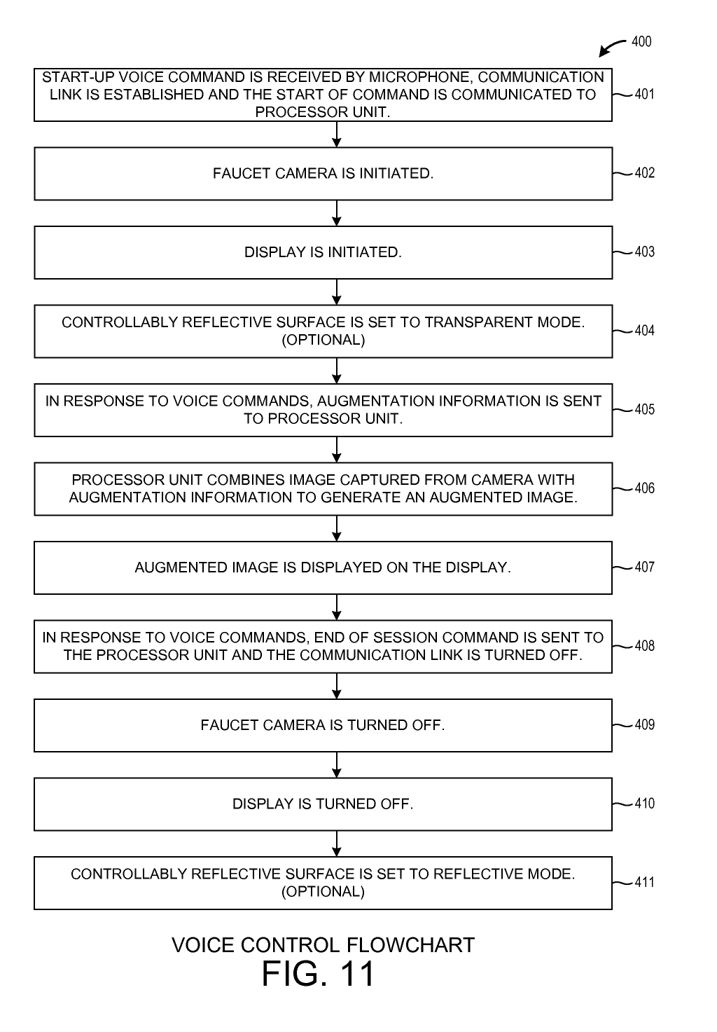

FIG. 11 is a flowchart 400 describing the operation of a voice controlled augmented image generation system with a faucet camera. In step 401, a start up voice command is received by the microphone integrated in the faucet and a wireless link is established between the wireless device in the faucet and the display. In step 402, the faucet cameras initiated. In step 403, the displays initiated. In step 404, the controllably reflective surface is set to transparent mode (optional). In step 405, a voice command indicating the augmentation information is sent to the processor unit. In step 406 the processor unit combines the captured image from the camera with the augmentation information to generate an augmented image. In step 407, the augmented image displayed in the display. In step 408, the user says an end of session command that is communicated to the processor unit and in response the processor unit turns off the wireless communication link. In step 409, the faucet cameras turned off. In step 410, the display is turned off. In step 411, the controllably reflective surface is sent to reflective mode (optional).

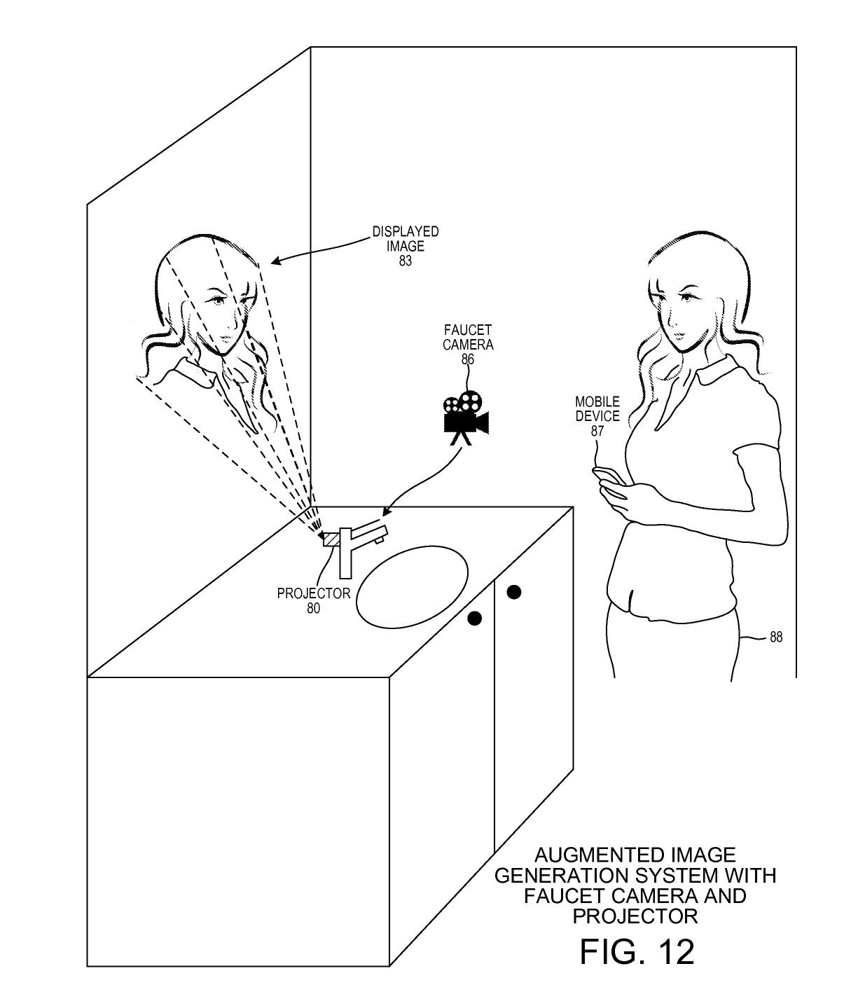

FIG. 12 is a diagram of a mobile device controlled augmented image generation system with a faucet camera that includes a mounted projector unit. The augmented image generation system includes a faucet with the integrated camera 86 and a mobile device 87. The augmented image generation system that allows a user 88 to display an augmented version of their image on any surface behind the faucet camera. FIG. 12 illustrates an example where the image is projected onto the wall behind faucet directly in front of the user.

In operation the user causes the mobile device to initiate a wireless communication link with both the faucet camera and the display. In response to initiating the wireless communication links, the mobile device prompts the user to stand within the focus range of the camera. The user then initiates image capturing via mobile device. The captured image is projected via the projector onto the surface behind the faucet camera in response to receiving a command from the mobile device to do so. The mobile device then prompt the user as to what type of image augmentation the user would like to be performed. The mobile device then performs the image augmentation and generates an augmented image that is based on the captured image and the augmentation information provided by the user. In one example the augmentation information is a preset makeup style, including different shades of lunch, eyeliner, and lipstick. In a second example the augmentation information includes hair color, hair length, and hairstyle. In a third example the augmentation information includes various clothing options, each in a selectable color and size. In a fourth example the augmentation information is limited to clothing owned by the user. In a fifth example the augmentation information is limited to makeup on by a user. The mobile device then communicates the augmented image to the display via the wireless and the augmented image is then projected onto a surface behind the faucet camera where the augmented image can be viewed by the user standing in front of the faucet camera. The user can use the mobile device to update both the captured image and the augmentation information, and cause the mobile device to generate a new automated image based on the new captured image or the new augmentation information. In response to the updated, the mobile device will generate a new augmented image and communicate the new augmented image to the wireless device in the faucet camera which will in turn cause the new augmented image to be projected onto the surface behind the faucet camera.

The user can also share the augmented image with another person by sending the augmented image to another device. This operation is performed by prompting the user with a sharing option, whereby the mobile device in response to the user selecting the sharing option communicates the augmented image to a second device. In one example the second device may be owned and operated by a friend of the user. In another example the secondary device may be a server that serves the image to a group of people who are friends with the user. In a third example the secondary device may be owned by a makeup or clothing manufacturer that wishes to market makeup and/or clothing goods to the user.

A faucet with an integrated camera and a wireless device, such as shown in FIGS. 4 and 5, can be used to implement the augmented image generation system shown in FIG. 12.

Although certain specific embodiments are described above for instructional purposes, the teachings of this patent document have general applicability and are not limited to the specific embodiments described above. Not all of the cameras and microphones need to be of identical construction. A mix of different types of camera, microphones, and lenses having different capabilities and limitations can be provided in the faucet. Accordingly, various modifications, adaptations, and combinations of various features of the described embodiments can be practiced without departing from the scope of the invention as set forth in the claims.

What is claimed is:

1. A faucet, comprising:
a water valve;
a handle that controls the valve;
a water spout;
a camera unit directed away from the faucet;
a data output means, wherein the camera unit is connected to the output data means; and
a power input means.

2. The faucet of claim 1, wherein the camera unit is integrated into the extended end of the handle, and wherein the power input means is a power port configured to connect to one selected from a group consisting of: an AC-to-DC power supply and a battery supply.

3. The faucet of claim 1, wherein the camera unit is not integrated into the faucet, and wherein the camera unit is detachable from the faucet.

4. The faucet of claim 1, wherein the faucet further comprises:
a microphone; and
an audio output means.

5. The faucet of claim 1, wherein the faucet further comprises:
a microphone, and wherein information captured by the camera unit and by the microphone is output by the data output means.

6. The faucet of claim 1, wherein the data output means is one selected from the group comprising: a wireless communication device, an output data cord, and an output data port, and wherein the output data port is one selected from the group consisting: an hdmi port, a usb port, a micro usb port, a mini display port, and a RS-232 port.

7. The faucet of claim 6, wherein the wireless communication device communicates using one wireless standard selected from the group, consisting of: bluetooth, Wi-Fi, ZigBee, GSM, LTE, and 3G.

8. The faucet of claim 3, wherein the camera unit is attached to the faucet with one selected from the group consisting of: a Velcro, a clamp, an epoxy, a double sided adhesive tape, a screw, a nut, a suction cup, and a band.

9. The faucet of claim 1, wherein the camera unit functions as a motion detector that detects when an object moves within a close distance to the faucet and outputs a wake up signal via the data output means to a processor unit.

10. The faucet of claim 1, further comprising:
a start button that causes a wake up signal to be sent to a processor unit via the data output means when pressed.

11. A method, comprising:
(a) establishing a wireless communication link between a camera unit and a mobile device, wherein the camera unit is attached to a faucet;
(b) establishing a wireless communication link between the mobile device and a processor unit, wherein the processing unit is coupled to a display device;
(c) in response to the establishing in (a), capturing an image via the camera unit;
(d) communicating the image from the camera unit to the mobile device;
(e) prompting a user of the mobile device to provide augmentation information;
(f) generating an augmented image based on the captured image and the augmentation information provided by the user;
(g) communicating the augmented image to the processor unit;
(f) displaying the augmented image on the display device, wherein the generating of (e) is performed by the mobile device, and wherein the displaying of (f) is performed by the display device.

12. The method of claim 11, wherein the camera unit comprises a wireless communication device that is used to communicate the captured image from the camera unit to the mobile device.

13. The method of claim 11, further comprising:
(e1) receiving augmentation information from the user, wherein the receiving of (e) is performed by mobile device.

14. The method of claim 11, wherein the camera unit is integrated into the faucet hardware, wherein the display device is located behind a Controlled Reflected Surface (CRS), and where in the CRS is set to be a reflective surface once the display device is turned off.

15. A method, comprising:
(a) generating a wake up signal that is communicated to a processor unit;
(b) capturing an image via a camera unit that is in communication with the processor unit, wherein the camera unit is attached to the faucet;
(c) displaying the captured image on a display device;
(d) displaying augmentation options on the display device;
(e) receiving augmentation information from a user;
(f) generating an augmented image based on the captured image and the augmentation information;
(g) displaying the augmented image on the display device, wherein the generating of (f) is performed by the processing unit, and wherein the displaying of (g) is performed by the display device.

16. The method of claim 15, wherein the wake up signal in (a) is generated by one of a group, consisting of: a depressed start button, by the camera detecting motion in close proximity to the faucet, and by a microphone in response to capturing a verbal command.

17. The method of claim 15, wherein the receiving of (e) is performed by a touch screen input device included in the display device, the method further comprising:
(h) communicating the augmented image to a second display device that can be viewed by a second user, wherein the second display device includes a means by which the second user can communicate feedback information regarding the augmented image to the first processing unit.

18. The method of claim 15, wherein the receiving of (e) is performed by a microphone included in the faucet, wherein data captured by the microphone is wirelessly communicated to the processing unit.

19. The method of claim 15, wherein the camera unit and the microphone communicate with the processor unit via wired communication.

20. The method of claim 15, wherein augmentation information includes a facial makeup combination.
